(19) United States
(12) Patent Application Publication
(10) Pub. No.: US 2021/0119884 A1
(43) Pub. Date: Apr. 22, 2021

(54) AUGMENTED REALITY NEIGHBOR AWARENESS NETWORKING

(71) Applicant: AVAGO TECHNOLOGIES INTERNATIONAL SALES PTE. LIMITED, Singapore (SG)

(72) Inventors: Jaeyoung Kim, Seoul (KR); Sang ku Lee, Seongnam-si (KR)

(73) Assignee: AVAGO TECHNOLOGIES INTERNATIONAL SALES PTE. LIMITED, Singapore (SG)

(21) Appl. No.: 16/656,921

(22) Filed: Oct. 18, 2019

(51) Int. Cl. H04L 12/24; H04W 76/10

(52) U.S. Cl. CPC H04L 41/22; H04L 41/0806; H04W 76/10

(57) ABSTRACT

An electronic device is configured to enhance a Neighbor Awareness Networking connection between the electronic device and an aware object using augmented reality. The electronic device includes a display and an imaging device. Additionally, the electronic device includes circuitry configured to receive information, including a recognition image, from each of one or more aware objects within a predetermined distance of the electronic device, recognize an aware object in a field of view of the imaging device based on the recognition image, establish a wireless connection with the recognized aware object, display an augmented reality composite image corresponding to the recognized aware object, and receive input at the display corresponding to interaction with the recognized aware object.

### BACKGROUND

Electronic devices such as smartphones with high-quality cameras are nearly ubiquitous, and the Internet of Things market continues to grow rapidly. However, the interactions between a smartphone and the world around it (e.g., electronic devices, objects that are not inherently electronic, and people) are still limited and rarely take advantage of the high-quality camera that comes standard in almost every smartphone. Neighbor Awareness Networking (NAN) has improved the ability to share information, particularly between electronic devices, by using peer-to-peer Wi-Fi, but the interactions using NAN are typically limited to file sharing, and after the file sharing is complete, the connection ends. Accordingly, any interaction between a person's smartphone and various other devices and/or people after the devices are connected by NAN is not part of the current NAN communication.

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

### SUMMARY

According to aspects of the disclosed subject matter, an electronic device is configured to enhance a Neighbor Awareness Networking connection between the electronic device and an aware object using augmented reality. The electronic device includes a display and an imaging device. Additionally, the electronic device includes circuitry configured to receive information, including a recognition image, from each of one or more aware objects within a predetermined distance of the electronic device, recognize an aware object in a field of view of the imaging device based on the recognition image, establish a wireless connection with the recognized aware object, display an augmented reality composite image corresponding to the recognized aware object, and receive input at the display corresponding to interaction with the recognized aware object.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an electronic device according to one or more aspects of the disclosed subject matter;

FIG. 2A illustrates a search phase according to one or more aspects of the disclosed subject matter;

FIG. 2B illustrates a recognition phase according to one or more aspects of the disclosed subject matter;

FIG. 2C illustrates a communication phase according to one or more aspects of the disclosed subject matter;

FIG. 3A illustrates an exemplary search phase for a passive aware object according to one or more aspects of the disclosed subject matter;

FIG. 3B illustrates an exemplary recognition phase for the passive aware object according to one or more aspects of the disclosed subject matter;

FIG. 3C illustrates an exemplary communication phase for the passive aware object according to one or more aspects of the disclosed subject matter;

FIG. 4A illustrates an exemplary search phase for an active aware object according to one or more aspects of the disclosed subject matter;

FIG. 4B illustrates an exemplary recognition phase for the active aware object according to one or more aspects of the disclosed subject matter;

FIG. 4C illustrates an exemplary communication phase for the active aware object according to one or more aspects of the disclosed subject matter;

FIG. 5A illustrates an exemplary search phase for a social aware object according to one or more aspects of the disclosed subject matter;

FIG. 5B illustrates an exemplary recognition phase for the social aware object according to one or more aspects of the disclosed subject matter;

FIG. 5C illustrates an exemplary communication phase for the social aware object according to one or more aspects of the disclosed subject matter;

FIG. 6A illustrates an exemplary recognition phase of the active aware object according to one or more aspects of the disclosed subject matter;

FIG. 6B illustrates an exemplary communication phase of the active aware object according to one or more aspects of the disclosed subject matter;

FIG. 7 is an algorithmic flow chart of a method for interacting with an aware object via augmented reality according to one or more aspects of the disclosed subject matter; and

FIG. 8 is a hardware block diagram of a device according to one or more exemplary aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

Referring now to the drawings, wherein like reference numerals designate identical or corresponding parts throughout the several views:

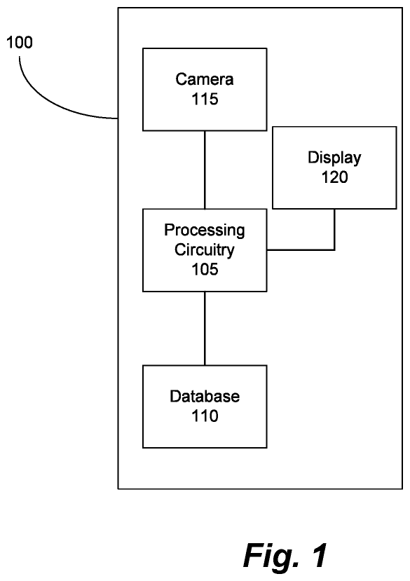

FIG. 1 illustrates an electronic device 100 (herein referred to as the device 100) according to one or more aspects of the disclosed subject matter. As will be discussed in more detail later, one or more methods according to various embodiments of the disclosed subject matter can be implemented using the device 100 or portions thereof. Put another way, the device 100, or portions thereof, can perform the functions or operations described herein regarding the various methods or portions thereof (including those implemented using a non-transitory computer-readable medium storing a program that, when executed, configures or causes a computer to perform or cause performance of the described method(s) or portions thereof).

The device 100 can include processing circuitry 105, a database 110, a camera 115, and a display 120. The device 100 can be a smartphone, a computer, a laptop, a tablet, a PDA, an augmented reality headset (e.g., helmet, visor, glasses, etc.), a virtual reality headset, a server, a drone, a partially or fully autonomous vehicle, and the like. Further, the aforementioned components can be electrically connected or in electrical or electronic communication with each other as diagrammatically represented by FIG. 1, for example.

Generally speaking, in one or more aspects of the disclosed subject matter, the device 100 including the processing circuitry 105, the database 110, the camera 115, and the display 120 can be implemented as various apparatuses that use augmented reality to enhance Neighbor Awareness Networking (NAN) (e.g., Wi-Fi Aware™, AirDrop, etc.). For example, the device 100 can recognize various objects and/or people using the camera 115. After the device 100 recognizes an object and/or person in a field of view of the camera 115, the device 100 can use augmented reality to enhance a user's view and/or interaction with the recognized object and/or person. In other words, the augmented reality aspect can include one or more computer-generated images and/or animations superimposed on a user's view of the real world, thus creating a composite image. Additionally, the user can interact with one or more of the augmented reality images and/or animations.

It should be appreciated that the implementations of the enhanced NAN can use a software application as a platform for the enhanced view and/or interaction with the display 120 of the device 105. For example, in one aspect, the device 105 can be a smartphone and the software application can be a smartphone application. In other words, the software application can be programmed to recognize objects and/or people in a field of view of the camera 115 via image processing, display the augmented reality composite image, receive interactions (e.g., touch input at the display 120), and perform any other processing further described herein.

More specifically, the device 100 can be configured to connect with other devices via Neighbor Awareness Networking (NAN). Wi-Fi Aware™ and AirDrop are implementations of Neighbor Awareness Networking and for the purposes of this description, NAN, Wi-Fi Aware™, and AirDrop can be used interchangeably. NAN can extend Wi-Fi capability with quick discovery, connection, and data exchange with other Wi-Fi devices—without the need for a traditional network infrastructure, internet connection, or GPS signal. Accordingly, NAN can provide rich here-and-now experiences by establishing independent, peer-to-peer Wi-Fi connections based on a user's immediate location and preferences. In one or more aspects of the disclosed subject matter, the device 100 can take advantage of NAN by receiving information from another device (e.g., an aware object), recognizing the aware object in a field of view of the camera 115, and wirelessly connecting with the aware object. After the device 100 connects with the aware object, the device 100 can use augmented reality to provide an enhanced view and/or interaction with the user's view of the real world. The aware object can correspond to another electronic device configured to connect with the device 105 in one or more of a passive, active, and social use case. The aware object can be (or can be associated with) any other electronic device with NAN capability. Examples of aware objects are further described herein.

The processing circuitry 105 can carry out instructions to perform or cause performance of various functions, operations, steps, or processes of the device 100. In other words, the processor/processing circuitry 105 can be configured to receive output from and transmit instructions to the one or more other components in the device 100 to operate the device 100 to use augmented reality in neighbor awareness networking.

The database 110 can represent one or more databases connected to the camera 115 and the display 120 by the processing circuitry 105. The database 110 can correspond to a memory of the device 100. Alternatively, or additionally, the database 110 can be an internal and/or external database (e.g., communicably coupled to the device 105 via a network). The database 110 can store information from one or more aware objects as further described herein.

The camera 115 can represent one or more cameras connected to the database 110 and the display 120 by the processing circuitry 105. The camera 115 can correspond to an imaging device configured to capture images and/or videos. Additionally, the camera 115 can be configured to work with augmented reality such that a composite image is displayed on the display 120 so that one or more computer-generated images and/or animations can be superimposed on a user's view of the real world (e.g., the view the user sees on the display 120 via the camera 115).

The display 120 can represent one or more displays connected to the database 110 and the camera 115 via the processing circuitry 120. The display 120 can be configured to detect interaction (e.g., touch input, input from peripheral devices, etc.) with the one or more augmented reality images and/or animations and the processing circuitry 105 can update the display based on the detected interaction. Alternatively, or additionally, the device 105 can be configured to receive voice commands to interact with the augmented reality features of the device 105.

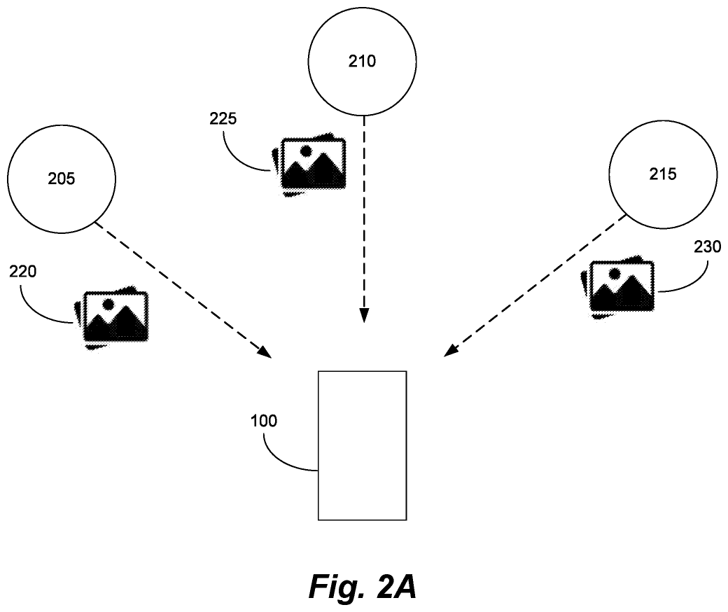

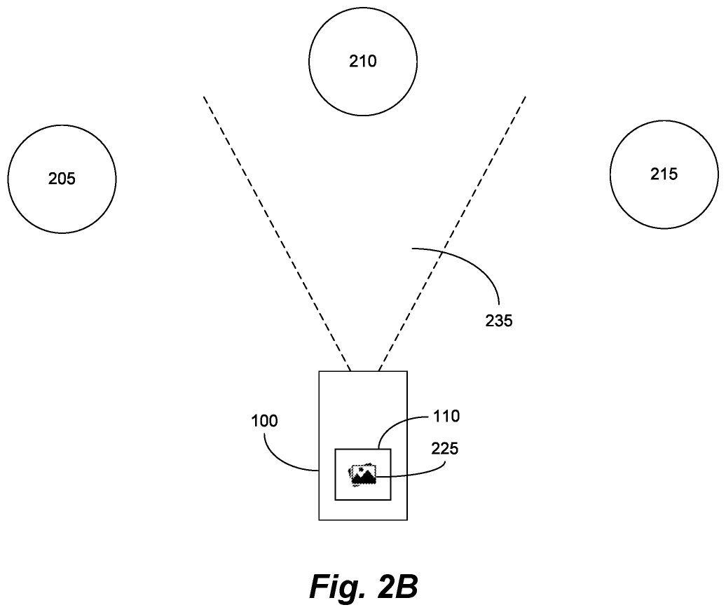

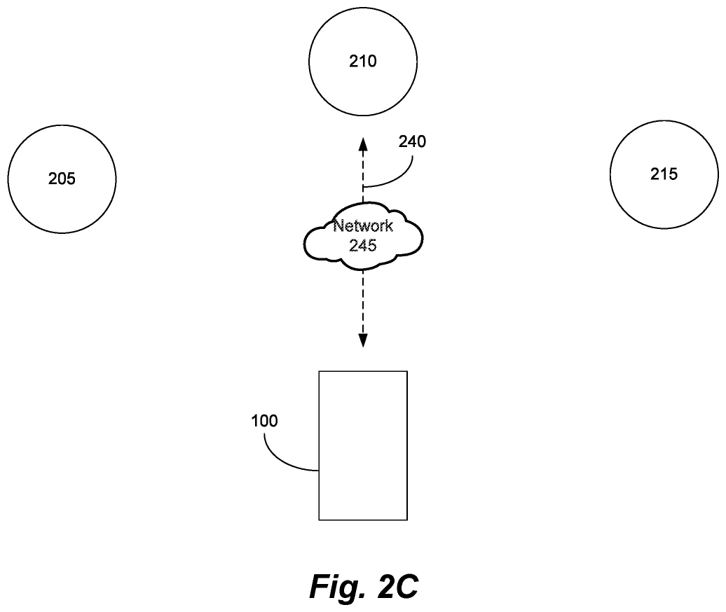

FIGS. 2A-2C illustrate an exemplary sequence of search, recognition, and communication phases corresponding to enhancing the NAN using augmented reality.

FIG. 2A illustrates a search phase according to one or more aspects of the disclosed subject matter. The search phase can correspond to the device 100 receiving information from one or more aware objects 205, 210, and 215. For example, aware object 205 can transmit information 220 to the device 100, aware object 210 can transmit information 225 to the device 100, and aware object 215 can transmit information 230 to the device 100. In particular, the information 220, 225, and 230 can at least include a recognition image. The recognition image corresponds to an image of the corresponding aware object that can be used by the device 100 to recognize the aware object in the recognition phase.

Additionally, the search phase can begin when the device 100 is within a predetermined distance of the one or more aware objects 205, 210, and 215. For example, although other methods of identifying a distance between two electronic devices can be contemplated, the predetermined distance can be established using a geofence so that when the device 100 enters the geofenced area, the one or more aware objects in the geofenced area can transmit information to the device 100. Further, it should be appreciated that having three aware objects 205, 210, and 215 is exemplary and any number of aware objects can be used.

FIG. 2B illustrates a recognition phase according to one or more aspects of the disclosed subject matter. After the search phase described in FIG. 2A, the device 100 has received a recognition image corresponding to each of the aware objects 205, 210, and 215. The recognition images can be stored in a memory of the device 100 (e.g., the database 110). Accordingly, for the recognition phase, the device 100 can recognize an aware object in a field of view 235 of the camera 115. For example, as illustrated in FIG. 2B, when the aware object 210 is in the field of view 235 of the camera 115, the processing circuitry 110 can compare the aware object 210 in the field of view 235 with the recognition image (i.e., included in information 225) stored in the database 110. When the processing circuitry 105 determines that the aware object 210 in the field of view matches the corresponding recognition image, the device 100 can recognize the aware object 210. After recognizing the aware object in the field of view of the camera, the device 100 can establish communication (e.g., NAN) with the recognized aware object.

Additionally, in an example where multiple aware objects (or people) are in the field of view 235 and recognized by comparing the aware objects and/or people in the field of view 235 with the corresponding recognition images stored in the database 110, the device 100 can be configured to receive a selection of one of the one or more recognized objects and/or people on the display 120. For example, the display 120 can be configured to receive touch input on the display 120 corresponding to a selection of one of the one or more aware objects and/or people on the display 120 to establish a wireless connection with for the communication phase. In other words, if all aware objects 205, 210, and 215 were in the field of view 235 of the camera 115 and recognized, a user can select the aware object 210 by touching the aware object 210 on the display 120, and in response to receiving the touch input, the device 100 can establish communication (e.g., NAN) with the aware device 210.

FIG. 2C illustrates a communication phase according to one or more aspects of the disclosed subject matter. The communication phase can correspond to establishing communication with the recognized aware object. As illustrated in FIG. 2C, the device 100 can establish communication (illustrated by line 240) via a network 245 (e.g., NAN corresponding to peer-to-peer Wi-Fi). The communication via the network 245 can be based on NAN which establishes independent, peer-to-peer Wi-Fi connections (e.g., Wi-Fi Aware™, AirDrop, etc.). Additionally, the peer-to-peer connection can be based on Bluetooth, for example. As further described herein, the communication between the device 100 and the recognized aware object can be enhanced using augmented reality.

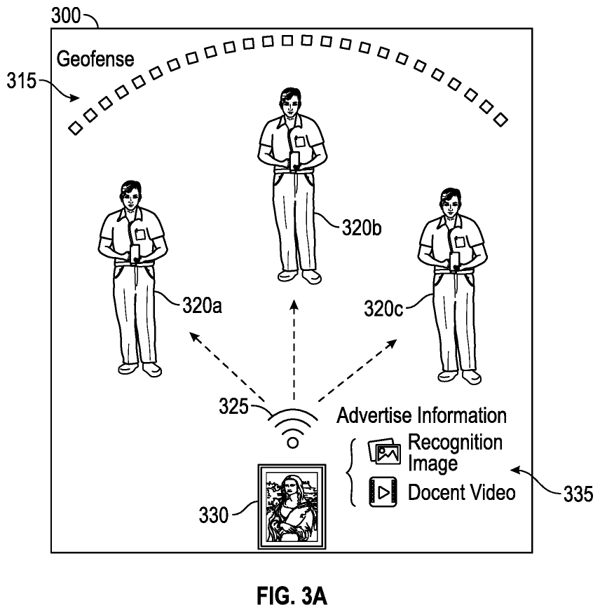

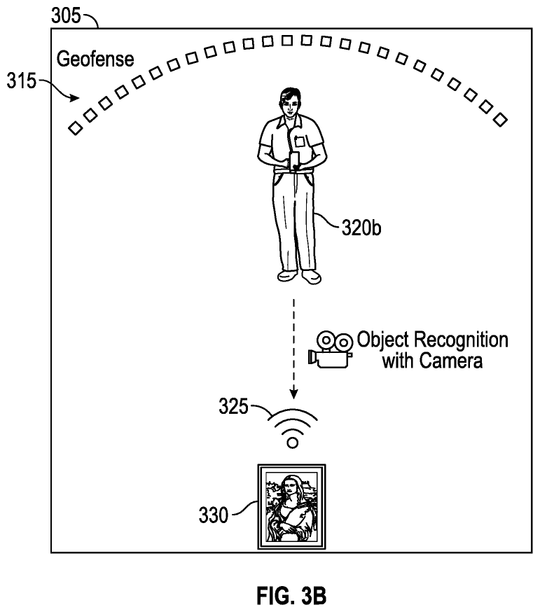

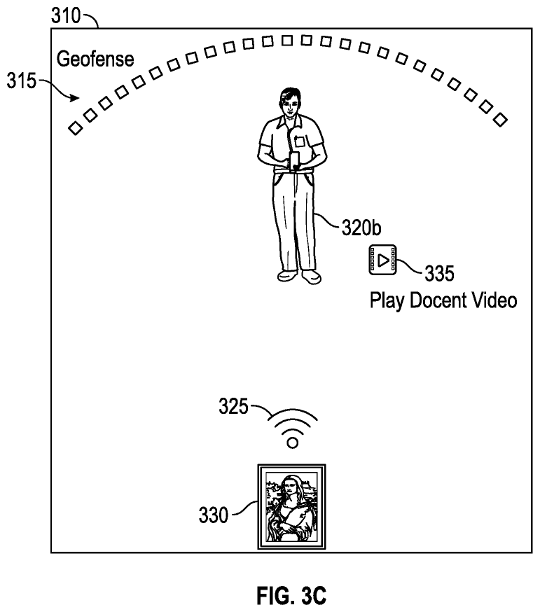

FIGS. 3A-3C illustrate an exemplary sequence for interacting with a passive aware object according to one or more aspects of the disclosed subject matter. For example, the sequence in FIGS. 3A-3C corresponds to the phases in FIGS. 2A-2C where FIG. 3A is a search phase 300, FIG. 3B is a recognition phase 305, and FIG. 3C is a communication phase 310. The sequence described in FIGS. 3A-3C illustrates an embodiment describing how the device 100 interacts with a passive aware object 330 such as a famous painting in a museum. In this case, the passive aware object 330 can be linked with an electronic device capable of NAN and transmitting information, receiving information, and storing information, for example. In other words, it should be appreciated that reference to the passive aware object 330 can include the object (e.g., the famous painting) and an electronic device linked to and/or associated with the object and configured to communicate with the device 100.

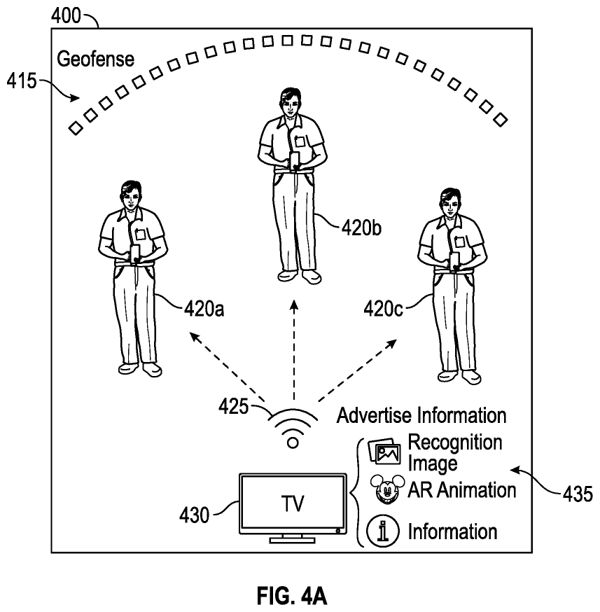

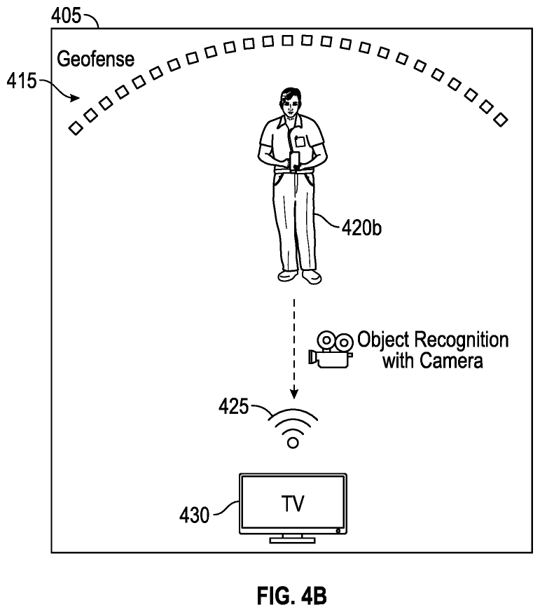

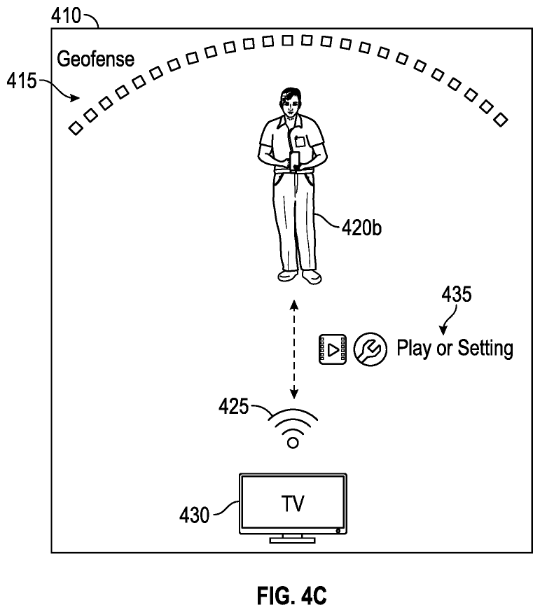

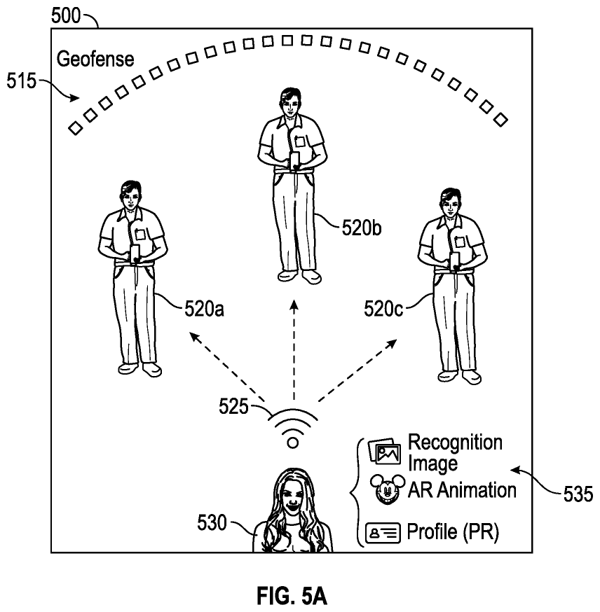

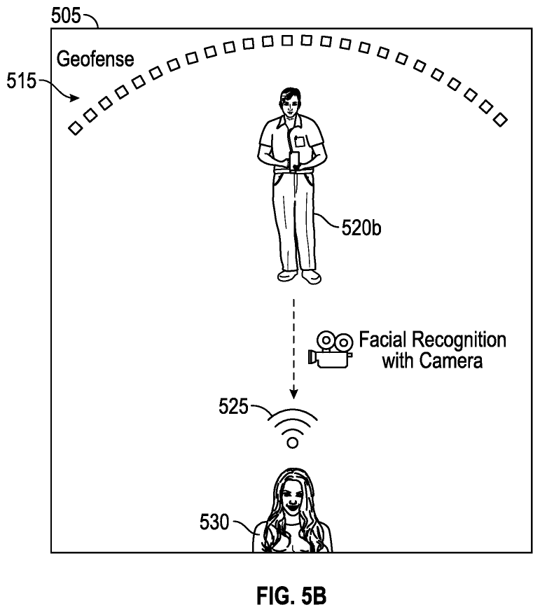

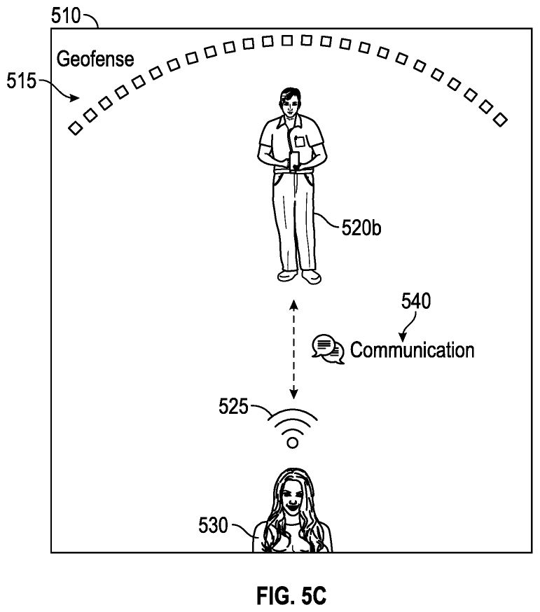

FIG. 3A illustrates an exemplary search phase 300 for a passive aware object 330 according to one or more aspects of the disclosed subject matter. Each of devices 320a, 320b, and 320c can be the device 100. In other words, each of 320a-c can correspond to a user using an electronic device like the device 100 where the numbers 320a-c are simply used to distinguish between different users in the illustration. Accordingly, reference to the device 320a, the device 320b, and the device 320c can correspond to a reference to the device 100 while distinguishing which user is being referenced (and similarly with references to devices 420a-c in FIGS. 4A-4C and devices 520a-c in FIGS. 5A-5C).

The example illustrated in FIG. 3A can be a museum where a famous painting is a passive aware object. For example, the passive aware object 330 can be the Mona Lisa. As has been described herein, while the Mona Lisa is being referred to as an aware object, the Mona Lisa itself is not an electronic device. Instead, the Mona Lisa can be associated with an electronic device such that a combination of the painting and the associated electronic device can be referred to as the aware object where the Mona Lisa is the object recognized by the device 100 during the recognition phase, but the associated electronic device handles the electronic communication between the aware object and the device 100. The aware object here can be referred to as a passive aware object based on the communication between the device 100 and the passive aware object. For example, although a user can interact with the passive aware object by viewing and interacting with an augmented reality composite image (e.g., pause/play a video received from the passive aware object), the interaction is distinguished from an active aware object (e.g., FIGS. 4A-4C) and a social aware object (FIGS. 5A-5C), as further described herein. For example, the device 100 may not be able to control the passive aware object via interaction with the display 120.

The passive aware object 330 can also have a corresponding geofence 315 establishing a geofenced area surrounding the aware object 330. Having a geofenced area for the aware object 330 can prevent unnecessary communication between the aware object and other electronic devices that are not within a predetermined distance from the aware object 330. Accordingly, when the devices 320a, 320b, and 320c cross the geofence 315, thereby entering the geofenced area for the aware object 330, the aware object 330 can transmit information 335 to the devices 320a, 320b, and 320c via a network 325 (e.g., Wi-Fi, Bluetooth, cellular, etc.). The information 335 can include a recognition image and details including additional information about the aware object 330 (e.g., a docent video), for example. After the aware object 330 transmits the information to the devices 320a, 320b, and 320c, the devices 320a, 320b, and 320c can enter the recognition phase 305.

FIG. 3B illustrates an exemplary recognition phase 305 for the passive aware object 330 according to one or more aspects of the disclosed subject matter. During the recognition phase 305, the passive aware object 330 can be in a field of view of the camera (e.g., camera 115) of the device 320b. While the passive aware object 330 is in a field of view of the device 320b, the processing circuitry (e.g., processing circuitry 105) can compare the passive aware object 330 with a recognition image stored in a database (e.g., database 110), the recognition image having been received as part of the information 335 transmitted from the passive aware object 330 in FIG. 3A. If the passive aware object 330 in the field of view of the device 320b matches the recognition image, the device 320b can establish communication (e.g., NAN) between the device 320b and the passive aware object 330 in the communication phase 310.

FIG. 3C illustrates an exemplary communication phase 310 for the passive aware object 330 according to one or more aspects of the disclosed subject matter. The communication phase 310 can correspond to establishing communication between the device 320b and the recognized passive aware object 330, and the established communication can be based on NAN (e.g., network 245 corresponding to peer-to-peer Wi-Fi). For example, in response to the connection between the device 320b and the passive aware object 330 being established, the device 320b can play a docent video (e.g., received with the information 325 transmitted to the device 320b from the passive aware object 330 when the device 320b entered the geofenced area) about the passive unaware object 330 (e.g., additional information about the Mona Lisa). Additionally, the display (e.g., the display 120) of the device 320b can further display augmented reality buttons for interaction with the docent video including pause and play buttons, for example. The user can end the communication between the device 320b and the passive aware object 330 by stopping the video, changing the field of view of the camera of the device 320b so the passive aware object 320b is no longer in the field of view of the device 320b, leave the geofenced area, and the like. Alternatively, the device 320b can be configured to maintain the communication between the device 320b and the passive aware object 330 even when the passive unaware object 330 is no longer in the field of view of the device 320b. For example, the connection can be maintained until the device 320b recognizes another aware object and/or leaves the geofenced area, for example.

FIGS. 4A-4C illustrate an exemplary sequence for interacting with an active aware object according to one or more aspects of the disclosed subject matter. For example, the sequence in FIGS. 4A-4C corresponds to the phases in FIGS. 2A-2C where FIG. 4A is a search phase 400, FIG. 4B is a recognition phase 405, and FIG. 4C is a communication phase 410. The sequence described in FIGS. 4A-4C illustrates an embodiment describing how the device 100 interacts with an active aware object 430.

FIG. 4A illustrates an exemplary search phase 400 for an active aware object 430 according to one or more aspects of the disclosed subject matter. In one embodiment, the active aware object 430 can be a television. Like the search phase 300 of FIG. 3A, the active aware object 430 can transmit information 435 via a network 425 to devices 420a, 420b, and 420c when the devices 420a, 420b, and 420c enter a geofenced area (i.e., cross a geofence 415) corresponding to the active aware object 430. The information 435 can include a recognition image, an augmented reality animation, and information about the active aware object 430 (e.g., television manufacturing information and/or television settings). The network 425 for transmitting the information 435 can be Wi-Fi, Bluetooth, cellular, and the like. After receiving the information 435, including the recognition image, the devices 420a, 420b, and 420c can recognize the active aware object 430 in the recognition phase 405.

FIG. 4B illustrates an exemplary recognition phase 405 for the active aware object 430 according to one or more aspects of the disclosed subject matter. Like the recognition phase 305 of FIG. 3B, during the recognition phase 405, the active aware object 430 can be in a field of view of the camera (e.g., camera 115) of the device 420b. While the active aware object 430 is in a field of view of the device 420b, the processing circuitry (e.g., processing circuitry 105) can compare the active aware object 430 with a recognition image stored in a database (e.g., database 110), the recognition image having been received as part of the information 435 transmitted from the active aware object 430 in FIG. 4A. If the active aware object 430 in the field of view of the device 420b matches the recognition image, the device 420b can establish communication (e.g., NAN) between the device 420b and the passive aware object 430 in the communication phase 410.

FIG. 4C illustrates an exemplary communication phase 410 for the active aware object 430 according to one or more aspects of the disclosed subject matter. The communication phase 410 can correspond to establishing communication between the device 420b and the recognized active aware object 430, and the established communication can be based on NAN (e.g., network 245 corresponding to peer-to-peer Wi-Fi). For example, in response to the connection between the device 420b and the active aware object 430 being established, the device 420b can display buttons in augmented reality so a user can access manufacturer information about the television, access settings of the television, start and/or pause the content on the television, and the like. Additionally, the device 420b can display an augmented reality animation that was received as part of the information 435. In other words, a user of the device 420b can interact with, communicate with, and/or control a functionality of the active aware object 430 via augmented reality displayed on the display 120 of the device 420b.

FIGS. 5A-5C illustrate an exemplary sequence for interacting with a social aware object according to one or more aspects of the disclosed subject matter. For example, the sequence in FIGS. 5A-5C corresponds to the phases in FIGS. 2A-2C where FIG. 5A is a search phase 500, FIG. 5B is a recognition phase 505, and FIG. 5C is a communication phase 510. The sequence described in FIGS. 5A-5C illustrates an embodiment describing how the device 100 interacts with a social aware object 530.

FIG. 5A illustrates an exemplary search phase 500 for a social aware object 530 according to one or more aspects of the disclosed subject matter. Like the search phases 300 and 400 of FIGS. 3A and 4A, respectively, the social aware object 530 can transmit information 535 via a network 525 to devices 520a, 520b, and 520c when the devices 520a, 520b, and 520c enter a geofenced area (i.e., cross a geofence 515) corresponding to the social aware object 530. The information 535 can include a recognition image, an augmented reality animation, and a profile corresponding to the social aware object 530. The profile portion of the information 535 can include information about the social aware object 530 including a name, a photo, a location, an introduction message, current communication availability (e.g., busy, available to connect, etc.), and the like. The network 525 for transmitting the information 535 can be Wi-Fi, Bluetooth, cellular, and the like. After receiving the information 535, including the recognition image, the devices 520a, 520b, and 520c can recognize the social aware object 530 in the recognition phase 505.

The social aware object 530 can be a person, for example. While the person here is being referred to as the social aware object 530, the person herself is not an electronic device. Instead, the person can be associated with an electronic device such that a combination of the person and the associated electronic device can be referred to as the aware object (and in this case the social aware object) where the person is the object recognized by the device 100 during the recognition phase, but the associated electronic device handles the electronic communication between the aware object and the device 100. In one example, the associated electronic device associated with the person can be another electronic device 100 (e.g., the person's smartphone or tablet). Alternatively, or additionally, the associated electronic device can be any electronic device capable of transmitting information, receiving information, and storing information via a NAN (e.g., network 245 corresponding to peer-to-peer Wi-Fi).

FIG. 5B illustrates an exemplary recognition phase 505 for the social aware object 530 according to one or more aspects of the disclosed subject matter. During the recognition phase 505, the social aware object 530 can be in a field of view of the camera (e.g., camera 115) of the device 520b. While the social aware object 530 is in a field of view of the device 520b, the processing circuitry (e.g., processing circuitry 105) can compare the social aware object 530 with a recognition image stored in a database (e.g., database 110), the recognition image having been received as part of the information 535 transmitted from the social aware object 530 in FIG. 5A. If the social aware object 530 in the field of view of the device 520b matches the recognition image, the device 520b can establish communication (e.g., NAN) between the device 520b and the social aware object 530 in the communication phase 510. It should be appreciated that the recognition processing for the recognition phase 505 can be facial recognition processing because the object being recognized is a person compared to the recognition phases 305 and 405 where an object is being recognized.

FIG. 5C illustrates an exemplary communication phase 510 for the social aware object 530 according to one or more aspects of the disclosed subject matter. The communication phase 510 can correspond to establishing communication between the device 520b and the recognized social aware object 530, and the established communication can be based on NAN (e.g., network 245 corresponding to peer-to-peer Wi-Fi). For example, in response to the connection between the device 520b and the social aware object 530 being established, the device 520b can display buttons, via the display 120, in augmented reality so a user can select an information button to view the person's profile and/or a messaging button to communicate with the person via messaging (e.g., communication 540), for example.

Additionally, a share button can be displayed in augmented reality so that the device 520b and the social aware object 530 can exchange data including files, images, videos, and the like (e.g., another instance of communication 540). Further, in response to the connection being established, the device 520b can display an augmented reality animation that was received as part of the information 535. In other words, a user of the device 530b can interact and/or communicate with the social aware object 530, and thus the person that is part of the social aware object 530, via augmented reality displayed on the display 120 of the device 420b.

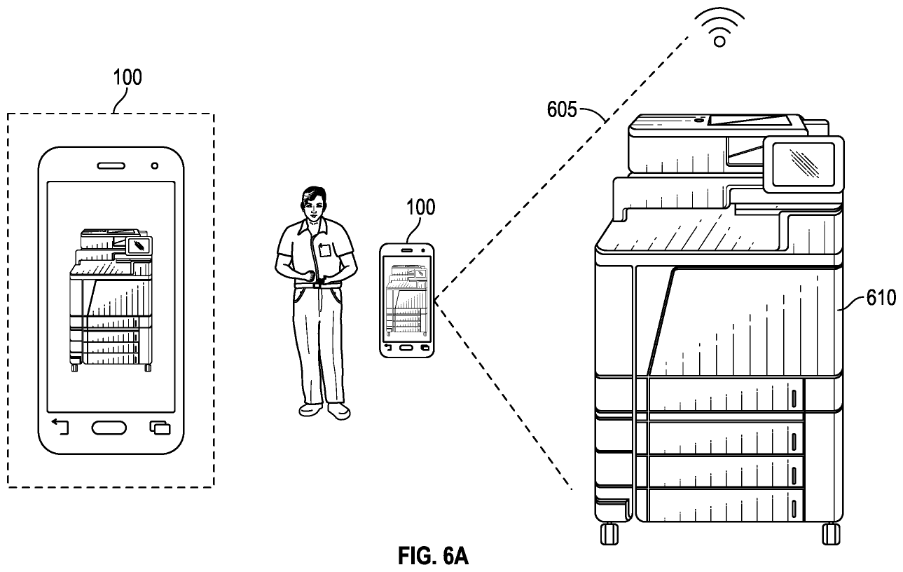

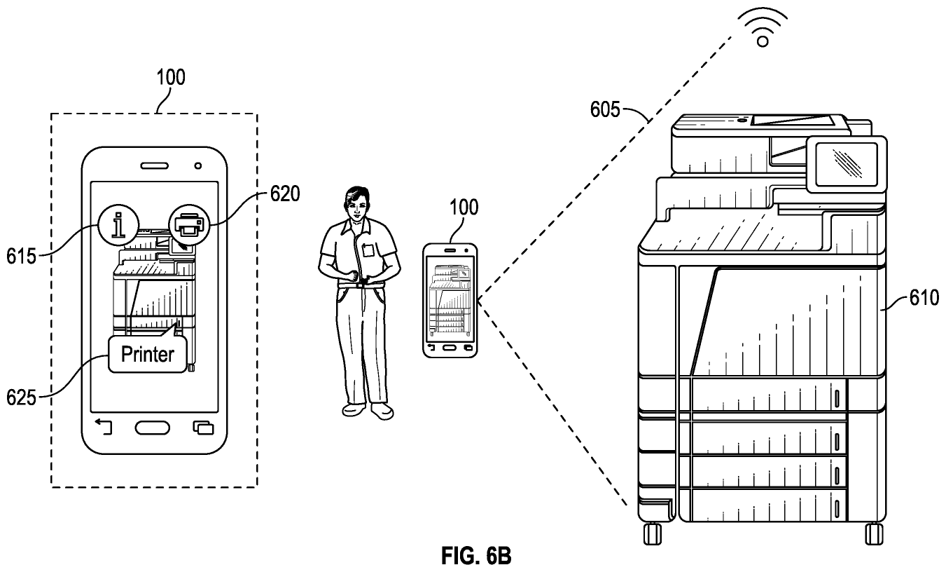

FIGS. 6A and 6B illustrate an exemplary recognition and communication phase for an active aware object 610 according to one or more aspects of the disclosed subject matter.

FIG. 6A illustrates an exemplary recognition phase of the active aware object 610 according to one or more aspects of the disclosed subject matter. It can be assumed for the description of FIGS. 6A and 6B that the search phase (e.g., as described in the search phase 405) already occurred so that the device 100 has information, including a recognition image, corresponding to the active aware object 610 stored in memory (e.g., the database 110). The active aware object 610 can be a printer. Additionally, the illustration of FIG. 6A includes a zoomed in view of the device 100 (dashed outline) to more clearly see the display (e.g., the display 120) of the device 100. FIG. 6A shows the active aware object 610 in a field of view 605 of the device 100 (e.g., a field of view of the camera 115). The device 100 can recognize the active aware object 610 by comparing the image of the active aware object 610 captured by the camera of the device 100 with the recognition image stored in a memory of the device 100 as described in FIG. 4B, for example. In response to recognizing the active aware object 610, the device 100 and the active aware object 610 can connect in a communication phase as illustrated in FIG. 6B.

FIG. 6B illustrates an exemplary communication phase of the active aware object 610 according to one or more aspects of the disclosed subject matter. The communication can be established by NAN as described in FIG. 4C, for example. As can be seen on the display of the zoomed in view of the device 100, augmented reality can be used to enhance the interaction between the device 100 and the active aware object 610. For example, the augmented reality can include an information button 615, a control button 620, and an identification bubble 625. The information button 615 can correspond to manufacturer information for the printer. In other words, selecting the information button 615 by touching the display of the device in the location of the information button 615 can display the manufacturer information. Similarly, the control button 620, upon receiving a touch interaction, can display options for controlling the printer (e.g., print, fax, copy, scan, change paper try, change between black and color ink for printing, etc.). The identification bubble 625 can display the brand and/or model of the printer, for example.

An advantage of establishing the communication between the device 100 and the active aware object 610 can include enhancing an interaction with the active aware object 610. The interaction can be enhanced in several ways. For example, in an embodiment where the device 100 is a smartphone, using the device 100 to control an active aware object like a printer can make it easier to identify manufacturing information, change the printer settings, and control the printer's functionality from the display of the smartphone. Additionally, the interaction can be further enhanced by adding augmented reality. The augmented reality buttons and/or animations can provide a better user experience. For example, the augmented reality buttons can be more intuitive. Many devices like printers include manufacturing and settings information, but it is often hidden behind layers of other information displayed on the small screen of a device like a printer, which can take several interactions (e.g., touch interactions, mouse clicks, etc.) to find. To the contrary, the buttons displayed via augmented reality can include an information button and a settings button to navigate a user directly to the information they need. Additionally, printers like the active aware object 610 can often include printing, faxing, copying, and scanning functionality. Another advantage of controlling the functionality of the active aware object 610 can include more intuitive selection of the desired functionality even without any familiarity with the active aware device 610 that is being interacted with. For example, different brands of printers often have different menus and different methods for navigating and using the functionality of the device. In other words, a user can operate any brand of printer by only being familiar with the device 100, effectively unifying interaction with different brands of any electronic devices. Accordingly, connecting the device 100 and the active aware object 610 via NAN can provide an enhanced user experience, and the user experience can be further enhanced with augmented reality.

It should be appreciated that the discussion of the advantages with respect to the active aware object as a printer is exemplary and any other electronic devices can be contemplated because the advantages can similarly easily be applied to any other electronic device that could fall into the category of an active aware object. Further, the same advantages can be applied to passive aware objects and social aware objects because similar advantages can be applied to enhancing the user experience.

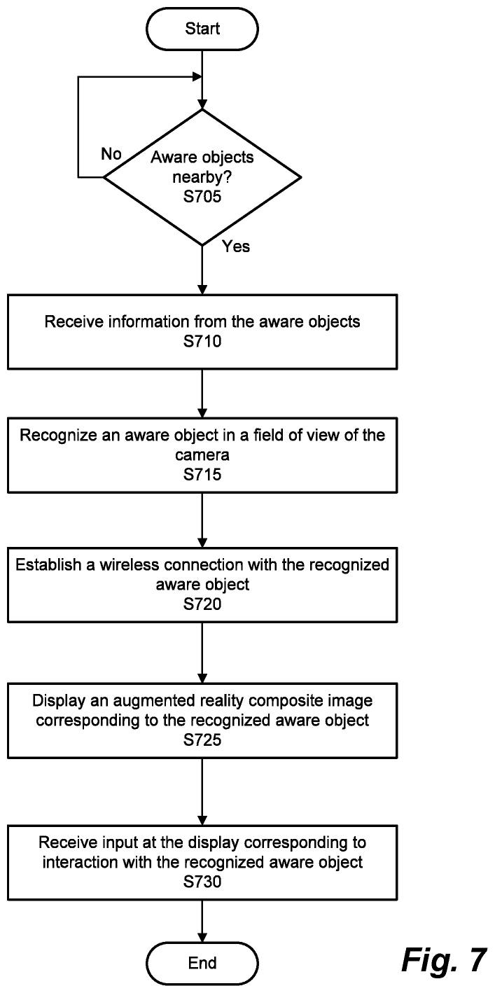

FIG. 7 is an algorithmic flow chart of a method for interacting with an aware object via augmented reality according to one or more aspects of the disclosed subject matter.

In S705, the device 100 can determine if any aware objects are nearby. It should be appreciated that aware objects can refer to passive, active, and social aware objects. In other words, it can be determined if aware objects are nearby based on entering a geofenced area, for example. Similarly, the aware objects can determine if the device 100 is within a predetermined distance when the device 100 enters the geofenced area. In other words, it can be determined that aware objects are nearby when at least one aware object is within a predetermined distance from the device 100. In response to a determination that no aware objects are nearby, the process can continue checking for any aware objects nearby. However, in response to a determination that there are aware objects nearby, the device 100 can receive information from the one or more aware objects that are within a predetermined distance of the device 100 in S710.

In S710, the device 100 can receive information from the one or more aware objects. For example, when the device 100 enters a geofenced area associated with one or more aware objects, each the one or more aware objects in the geofenced area can transmit its own information to the device 100. The information can change depending on the type of aware object (e.g., passive, active, social) as has been described herein, but can at least include a recognition image used to recognize the aware object. The device 100 can store the information received from the aware objects in memory (e.g., the database 110).

In S715, the device 100 can recognize an aware object in a field of view of the camera (e.g., camera 115) of the device 100. For example, the image of the field of view of the camera 115 is simultaneously displayed on the display 120 of the device 100. As has been described herein, when an aware object is in the field of view, the device 100 (via the processing circuitry 105) can recognize the aware object based on a match between the aware object in the field of view and the recognition image received in the information in S710.

In S720, the device 100 can establish a wireless connection with the recognized aware object. For example, the device 100 can establish communication with an aware object that was recognized in S715. The communication can be based on NAN (e.g., via network 245 based on peer-to-peer Wi-Fi) so that the device 100 and the recognized aware object can interact as has been described in FIGS. 2A-6B. In other words, the NAN can correspond to Wi-Fi Aware™ and AirDrop.

In S725, in response to establishing the communication between the device 100 and the aware object in S720, the device 100 can display an augmented reality composite image corresponding to the recognized aware object. For example, the augmented reality can be based at least in part on the information received in S710. In one embodiment, the augmented reality displayed can include one or more buttons for further interaction with the aware object, an augmented reality animation, an identification bubble, and the like.

In S730, the device 100 can receive input at the display (e.g., the display 120) corresponding to interaction with the recognized aware object. For example, while other similar interactions can be contemplated in other embodiments, the interaction can correspond to touch input on a smartphone. The input received at the display can allow various interactions with the aware object that significantly improve the user experience. For example, a user can press one of the augmented reality buttons to view options to control the aware object via the device 100. For example, if the aware device is a printer, the user can select a print functionality via one of the augmented reality buttons displayed on the device 100 based on the NAN connection between the device 100 and the aware object.

Accordingly, the user experience can be improved by the augmented reality features because they can be more intuitive, make the information and features of the aware device more accessible, and the like.

In the above description of FIG. 7, any processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

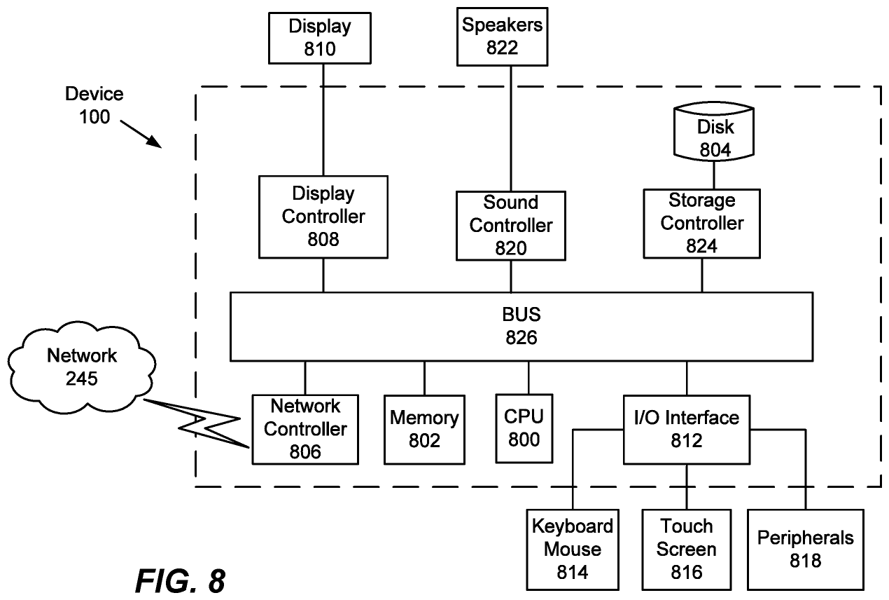

Next, a hardware description of an electronic device (e.g., the device 100) according to exemplary embodiments is described with reference to FIG. 8. The hardware description described herein can also be a hardware description of the processing circuitry. In FIG. 8, the device 100 includes a CPU 800 which performs one or more of the processes described above/below. The process data and instructions may be stored in memory 802. These processes and instructions may also be stored on a storage medium disk 804 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 100 communicates, such as a server or computer.

Further, the claimed advancements may be provided as a utility application, background daemon, or component of an operating system, or combination thereof, executing in conjunction with CPU 800 and an operating system such as Microsoft Windows, UNIX, Solaris, LINUX, Apple MAC-OS and other systems known to those skilled in the art.

The hardware elements in order to achieve the device 100 may be realized by various circuitry elements. Further, each of the functions of the above described embodiments may be implemented by circuitry, which includes one or more processing circuits. A processing circuit includes a particularly programmed processor, for example, processor (CPU) 800, as shown in FIG. 8. A processing circuit also includes devices such as an application specific integrated circuit (ASIC) and conventional circuit components arranged to perform the recited functions.

In FIG. 8, the device 100 includes a CPU 800 which performs the processes described above. The device 100 may be a general-purpose computer or a particular, special-purpose machine. In one embodiment, the device 100 becomes a particular, special-purpose machine when the processor 800 is programmed to enhance interaction with an aware object through augmented reality via a NAN (and in particular, any of the processes discussed with reference to FIG. 7).

Alternatively, or additionally, the CPU 800 may be implemented on an FPGA, ASIC, PLD or using discrete logic circuits, as one of ordinary skill in the art would recognize. Further, CPU 800 may be implemented as multiple processors cooperatively working in parallel to perform the instructions of the inventive processes described above.

The device 100 in FIG. 8 also includes a network controller 806, such as an Intel Ethernet PRO network interface card from Intel Corporation of America, for interfacing with network 245. As can be appreciated, the network 245 can be a NAN, such as peer-to-peer Wi-Fi, a public network, such as the Internet, or a private network such as an LAN or WAN network, or any combination thereof and can also include PSTN or ISDN sub-networks. The network 245 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The device 100 further includes a display controller 808, such as a graphics card or graphics adaptor for interfacing with display 810, such as a monitor. A general purpose I/O interface 812 interfaces with a keyboard and/or mouse 814 as well as a touch screen panel 816 on or separate from display 810. General purpose I/O interface also connects to a variety of peripherals 818 including printers and scanners.

A sound controller 820 is also provided in the device 100 to interface with speakers/microphone 822 thereby providing sounds and/or music.

The general-purpose storage controller 824 connects the storage medium disk 804 with communication bus 826, which may be an ISA, EISA, VESA, PCI, or similar, for interconnecting all of the components of the device 100. A description of the general features and functionality of the display 810, keyboard and/or mouse 814, as well as the display controller 808, storage controller 824, network controller 806, sound controller 820, and general purpose I/O interface 812 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

1. An electronic device, comprising:
a display;
an imaging device; and
circuitry configured to
receive information, including a recognition image, from each of one or more aware objects within a predetermined distance of the electronic device,
recognize an aware object in a field of view of the imaging device based on the recognition image,
establish a wireless connection with the recognized aware object,
display an augmented reality composite image corresponding to the recognized aware object, and
receive input at the display corresponding to interaction with the recognized aware object.

2. The electronic device of claim 1, wherein the recognized aware object is a passive aware object.

3. The electronic device of claim 2, wherein in response to the recognized aware object being the passive aware object, the information received from the passive aware object includes details about the passive aware object in addition to the received recognition image.

4. The electronic device of claim 1, wherein the recognized aware object is an active aware object.

5. The electronic device of claim 4, wherein in response to the recognized aware object being the active aware object, the information received from the active aware object includes one or more of information about the active aware object, a settings menu for the active aware object, and an augmented reality animation, in addition to the recognition image.

6. The electronic device of claim 1, wherein the recognized aware object is a social aware object.

7. The electronic device of claim 6, wherein in response to the recognized aware object being the social aware object, the information received from the social aware object includes one or more of an augmented reality animation and a profile of the social aware object, in addition to the recognition image.

8. The electronic device of claim 1, wherein being within the predetermined distance of the electronic device corresponds to the electronic device entering a geofenced area.

9. The electronic device of claim 1, wherein the circuitry is further configured to recognize a plurality of aware objects in the field of view of the imaging device.

10. The electronic device of claim 9, wherein the circuitry is further configured to receive a selection corresponding to one of the plurality of recognized aware objects to establish the wireless connection with the selected recognized aware object.

11. A method, comprising:
receiving, by circuitry, information, including a recognition image, from each of one or more aware objects within a predetermined distance of an electronic device;
recognizing, by the circuitry, an aware object in a field of view of an imaging device based on the recognition image;
establishing, by the circuitry, a wireless connection with the recognized aware object;
displaying, by the circuitry, an augmented reality composite image corresponding to the recognized aware object; and
receiving, by the circuitry, input at a display corresponding to interaction with the recognized aware object.

12. The method of claim 11, wherein the recognized aware object is a passive aware object.

13. The method of claim 12, in response to the recognized aware object being the passive aware object, further comprising:
receiving information from the passive aware object, wherein the information includes details about the passive aware object in addition to the received recognition image.

14. The method of claim 11, wherein the recognized aware object is an active aware object.

15. The method of claim 14, in response to the recognized aware object being the active aware object, further comprising:
receiving information from the active aware object, wherein the information includes one or more of information about the active aware object, a settings menu for the active aware object, and an augmented reality animation, in addition to the recognition image.

16. The method of claim 11, wherein the recognized aware object is a social aware object.

17. The method of claim 16, wherein in response to the recognized aware object being the social aware object, further comprising:
receiving information from the social aware object, wherein the information includes one or more of an augmented reality animation and a profile of the social aware object, in addition to the recognition image.

18. The method of claim 11, wherein being within the predetermined distance of the electronic device corresponds to entering a geofenced area.

19. The method of claim 11, further comprising:
recognizing a plurality of aware objects in the field of view of the imaging device; and
receiving a selection corresponding to one of the plurality of recognized aware objects to establish the wireless connection with the selected recognized aware object.

20. A non-transitory computer-readable storage medium storing computer readable instructions thereon which, when executed by a computer, cause the computer to perform a method, the method comprising:
receiving information, including a recognition image, from each of one or more aware objects within a predetermined distance of an electronic device;
recognizing an aware object in a field of view of an imaging device based on the recognition image;
establishing a wireless connection with the recognized aware object;
displaying an augmented reality composite image corresponding to the recognized aware object; and
receiving input at a display corresponding to interaction with the recognized aware object.
